(19) United States
(12) Patent Application Publication
(10) Pub. No.: US 2020/0026428 A1
(43) Pub. Date: Jan. 23, 2020

(54) SMART AUTO-BACKUP OF VIRTUAL MACHINES USING A VIRTUAL PROXY

(71) Applicant: EMC IP Holding Company LLC, Hopkinton, MA (US)

(72) Inventors: Suraj Dayanand Vithalkar, Bangalore (IN); Paloth Parambil Shahid, Calicut (IN); Sharath Talkad Srinivasan, Bengaluru (IN)

(21) Appl. No.: 16/042,496

(22) Filed: Jul. 23, 2018

(51) Int. Cl. G06F 3/06

(52) U.S. Cl. CPC G06F 3/065; G06F 3/0619; G06F 9/45558; G06F 3/067; G06F 3/0664

(57) ABSTRACT

A method and system for implementing smart auto-backups of virtual machines using a virtual proxy. Specifically, the method and system disclosed herein overcome the potential for data loss when failure events transpire between schedule system-initiated backup operations. Data loss, more specifically, may be averted through the triggering of the smart auto-backups during the period of time elapsed between successive scheduled system-initiated backup operations. Further, the triggering may be based on the meeting of two criterion representative of an input-output (IO) operations threshold and an elapsed time threshold

### BACKGROUND

In most cases, application-consistent backups, which provide the highest level of protection and consistency for data, execute as scheduled backups that are triggered periodically. Suppose, however, that a substantial amount of input-output (IO) operations transpires, followed by a failure event, prior to the triggering of a next scheduled backup. The aftermath would include the loss of data, generated and/or changed by the aforementioned IO operations, as well as the loss of any chance of data recovery because the next scheduled backup had not occurred.

### BRIEF DESCRIPTION OF DRAWINGS

FIG. 1 shows a system in accordance with one or more embodiments of the invention.

FIGS. 2A and 2B show flowcharts describing a method for triggering an auto-backup of a virtual machine using a virtual proxy in accordance with one or more embodiments of the invention.

FIG. 3 shows a computing system in accordance with one or more embodiments of the invention.

FIG. 4 shows an example scenario in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

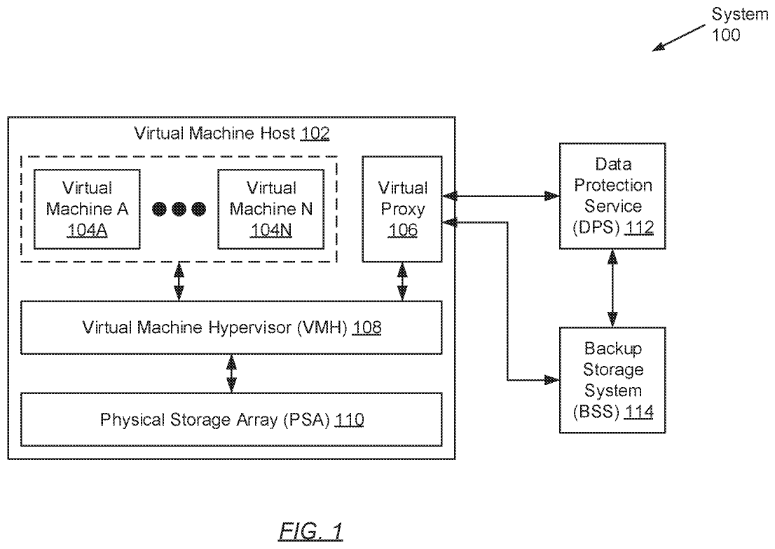

In the following description of FIGS. 1-4, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments of the invention relate to a method and system for implementing smart auto-backups of virtual machines using a virtual proxy. Specifically, one or more embodiments of the invention overcome the potential for data loss when failure events transpire between schedule system-initiated backup operations. Data loss, more specifically, may be averted through the triggering of the smart auto-backups during the period of time elapsed between successive scheduled system-initiated backup operations. Further, the triggering may be based on the meeting of two criterion representative of an input-output (IO) operations threshold and an elapsed time threshold.

FIG. 1 shows a system in accordance with one or more embodiments of the invention. The system (100) may include a virtual machine host (102) operatively connected to a data protection service (DPS) (112) and a backup storage system (BSS) (114). The DPS (112) and the BSS (114) may further be operatively connected to each other. Each of these components is described below.

In one embodiment of the invention, the above-mentioned components may be directly or indirectly connected to one another through a network (not shown) (e.g., a local area network (LAN), a wide area network (WAN) such as the Internet, a mobile network, or any other network). The network may be implemented using any combination of wired and/or wireless connections. In embodiments in which the above-mentioned components are indirectly connected, there may be other networking components or systems (e.g., switches, routers, gateways, etc.) that facilitate communications, information exchange, and/or resource sharing. Further, the above-mentioned components may communicate with one another using any combination of wired and/or wireless communication protocols.

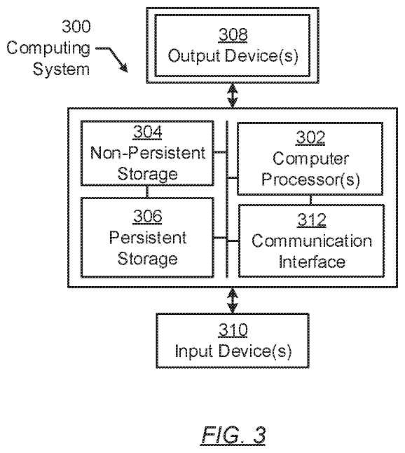

In one embodiment of the invention, the virtual machine host (102) may be any physical computing system (see e.g., FIG. 3) on which one or more virtual machines (104A-104N) may be executing. Each virtual machine (104A-104N) may be a computer program that emulates a physical computing system and, thus, provides a self-contained execution environment on which one or more other computer programs (e.g., guest operating systems (OSs) and/or applications) may execute. Further, each virtual machine (104A-104N) may access the underlying virtual machine host (102) hardware and interact with other host components using an abstraction layer—e.g., the virtual machine hypervisor (VMH) (108). Moreover, each virtual machine (104A-104N) may include functionality to generate disk input-output (IO) operations directed to reading data from and writing data to a corresponding virtual machine disk set (not shown) residing on the physical storage array (PSA) (110).

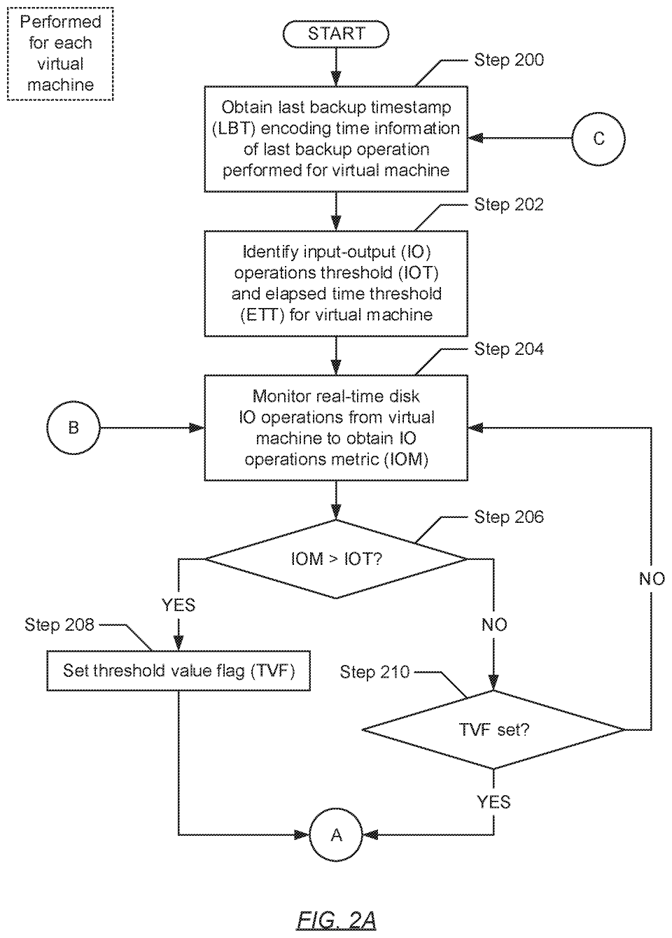

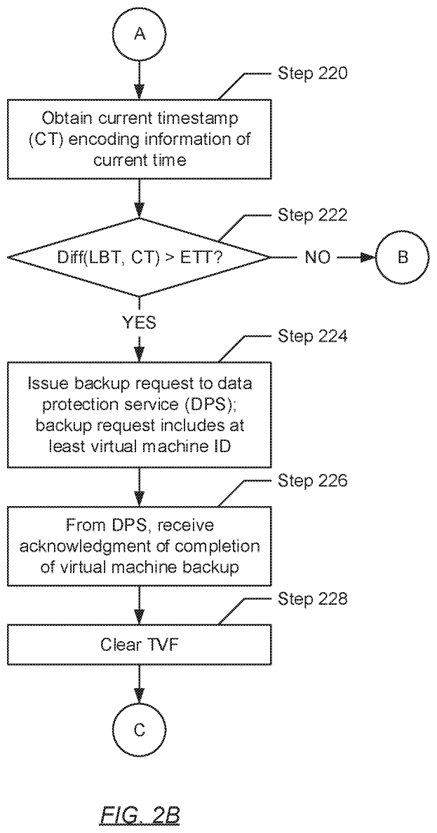

In one embodiment of the invention, the virtual machine host (102) may further include a virtual proxy (106). The virtual proxy (106) may be a specialized virtual machine, or a computer program, tasked with triggering the smart auto-backup of virtual machines in accordance with one or more embodiments of the invention (see e.g., FIGS. 2A and 2B). Specifically, the virtual proxy (106) may include functionality to, for each virtual machine (104A-104N) executing on the virtual machine host (102): monitor their disk IO operations to obtain IO operations metrics (IOM); and assess whether to trigger the auto-backup of the virtual machine based on the IOM exceeding or falling short of an IO operations threshold (IOT), and an elapsed time since the last backup of the virtual machine exceeding or falling short of an elapsed time threshold (ETT).

In one embodiment of the invention, the virtual machine host (102) may further include a VMH (108). The VMH (108) may be a computer program or process (i.e., an instance of a computer program) that executes on the underlying hardware of the virtual machine host (102). Specifically, the VMH (108) may be a computer program or process tasked with the management of one or more virtual machines (104A-104N). To that extent, the VMH (108) may include functionality to: create or delete virtual machines (104A-104N); allocate or deallocate virtual machine host (102) resources to support the execution of the virtual machines (104A-104N) and their respective workloads; manage intra-host communication between the virtual machines (104A-104N) and other virtual machine host (102) components (e.g., the virtual proxy (106) and the physical storage array (PSA) (110)); and maintain IO performance metrics (e.g., IO throughput, IO bandwidth, IO latency, etc.) pertaining to IO operations generated by the various virtual machines (104A-104N). One of ordinary skill will appreciate that the VMH (108) may perform other functionalities without departing from the scope of the invention.

In one embodiment of the invention, the virtual machine host (102) may further include a physical storage array (PSA) (110). The PSA (110) may encompass one or more physical storage devices and/or media on which various forms of information—pertinent to at least the virtual machine host (102), the virtual machines (104A-104N), the virtual proxy (106), and the VMH (108)—may be consolidated. For example, the PSA (110) may provide physical storage capacity for the consolidation of one or more virtual machine disk sets (not shown), which may store virtual machine state, as well as virtual machine configuration and metadata information. Further, the one or more physical storage devices and/or media may or may not be of the same type or co-located in the same physical site. The information consolidated in the PSA (110) may be arranged using any storage mechanism (e.g., a filesystem, a collection of tables or records, etc.). In one embodiment of the invention, the PSA (110) may be implemented using persistent (i.e., non-volatile) storage. Examples of persistent storage include, but are not limited to: optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one embodiment of the invention, the DPS (112) may be a virtual machine backup, archiving, and/or disaster recovery service. The DPS (112) may be implemented on one or more servers (not shown). Each server may be a physical server (i.e., within a datacenter) or a virtual server (i.e., residing in a cloud computing environment). In one embodiment of the invention, the DPS (112) may be implemented on one or more computing systems similar to the computing system shown in FIG. 3. Further, the DPS (112) may include functionality to: receive backup requests from the virtual proxy (106), where the backup requests pertain to initiating a backup operation entailing one or more virtual machines (104A-104N); in response to receiving backup requests, replicate virtual machine disk sets (not shown) pertinent to the virtual machine(s) (104A-104N), which form, at least in part, the PSA (110); consolidate the replicated virtual machine disk sets on the BSS (114); and upon completion of the backup operations, issue acknowledgments of completion back to the virtual proxy (106). One of ordinary skill will appreciate that the DPS (112) may perform other functionalities without departing from the scope of the invention.

In one embodiment of the invention, the BSS (114) may be a data backup, archiving, and/or disaster recovery storage system. The BSS (114) may be implemented on one or more servers (not shown). Each server may be a physical server (i.e., within a datacenter) or a virtual server (i.e., residing in a cloud computing environment). In one embodiment of the invention, the BSS (114) may be implemented on one or more computing systems similar to the exemplary computing system shown in FIG. 3. Further, the BSS (114) may include one or more physical storage devices and/or media (not shown) on which the various virtual machine state, configuration, and other relevant information may be consolidated. The one or more physical storage devices and/or media may or may not be of the same type or co-located in the same physical site. Moreover, the information stored in the BSS (114) may be arranged using any storage mechanism (e.g., a filesystem, a collection of tables or records, etc.). In one embodiment of the invention, the BSS (114) may be implemented using persistent (i.e., non-volatile) storage. Examples of persistent storage include, but are not limited to: optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

While FIG. 1 shows a configuration of components, other system configurations may be used without departing from the scope of the invention.

FIGS. 2A and 2B show flowcharts describing a method for triggering an auto-backup of a virtual machine using a virtual proxy in accordance with one or more embodiments of the invention. The various steps outlined below may be performed by the virtual proxy (see e.g., FIG. 1). Further, while the various steps in the flowcharts are presented and described sequentially, one of ordinary skill will appreciate that some or all steps may be executed in different orders, may be combined or omitted, and some or all steps may be executed in parallel.

Turning to FIG. 2A, in Step 200, for any virtual machine executing on a virtual machine host (see e.g., FIG. 1), a last backup timestamp (LBT) associated with the virtual machine is obtained. In one embodiment of the invention, the LBT may represent encoded information that marks the date and/or time that the last (or latest) backup operation for the virtual machine had been performed. The last/latest backup operation may have pertained to a full backup or, alternatively, to an incremental backup. Further, in one embodiment of the invention, the last/latest backup operation may have been a system-initiated backup, which may be set to execute periodically at a predetermined interval of time. In another embodiment of the invention, the last/latest backup operation may have been a previously triggered auto-backup.

In Step 202, an input-output (IO) operations threshold (IOT) and an elapsed time threshold (ETT) for the virtual machine are identified. In one embodiment of the invention, the IOT and ETT may represent a first and second criterion, respectively, for triggering an auto-backup of the virtual machine. Specifically, the IOT may designate a minimum quantitative value, representative of IO operations submitted by the virtual machine, required (in conjunction with the ETT) to trigger the auto-backup. Further, the ETT may designate a minimum elapsed length of time, since the LBT (obtained in Step 200), required (in conjunction with the IOT) to trigger the auto-backup.

In one embodiment of the invention, the IOT may be determined based on historical IO operations information for the virtual machine, which may be maintained by a virtual machine hypervisor (VMH). The VMH may be responsible for managing and tracking a history of, at least, the read and/or write requests (i.e., IO operations) from the virtual machine to a physical storage array (PSA) directed to retrieving and/or storing data. Historical information pertaining to IO operations may take form as one or more disk IO-pertinent performance metrics such as, for example, throughput (measured in IO operations per second (IOPS)), bandwidth (measured in bits per second (bps) or bytes per second (Bps)), and/or latency (measured in milliseconds (ms)). Further, the historical IO operations information may span across any granularity of time.

In one embodiment of the invention, the IOT may represent a quantitative value that relates (or is proportional) to a summary statistic of the historical IO operations information for the virtual machine. Summary statistics represent measures used to summarize a dataset, which may include, but are not limited to: location or central tendency measures (e.g., arithmetic mean, median, mode, and interquartile mean), spread or dispersion measures (e.g., standard deviation, variance, range, interquartile range, etc.), shape measures (e.g., skewness or kurtosis), and dependence measures (e.g., correlation). By way of an example, the IOT may be expressed as a percentage of a summary statistic of the historical IO operations information—e.g., 150% of an arithmetic mean of the historical IO throughput (measured in IOPS) observed across a granularity of time for the virtual machine.

In one embodiment of the invention, the ETT may be determined based on the time interval between scheduled system-initiated backups that has been set. That is, generally, the ETT may span any granularity of time that is less than the set time interval between scheduled system-initiated backups of the virtual machine state for the virtual machine. For example, if the system-initiated backups are set to occur every 24 hours, the ETT may be set to any granularity of time below 24 hours.

In Step 204, real-time disk IO operations from the virtual machine are monitored, to obtain an IO operations metric (IOM). Specifically, in one embodiment of the invention, IOMs may be polled (i.e., requested and subsequently obtained) from the VMH at predetermined time intervals. The IOMs, like the historical IO information (described above), may take form as one or more disk IO-pertinent performance metrics such as, for example, throughput (measured in IO operations per second (IOPS)), bandwidth (measured in bits per second (bps) or bytes per second (Bps)), and/or latency (measured in milliseconds (ms)).

In Step 206, a determination is made as to whether the instant IOM (obtained in Step 204) exceeds the IOT (identified in Step 202). In one embodiment of the invention, the disk IO-pertinent performance metric (e.g., throughput, bandwidth, latency, etc.) captured by both the IOM and the IOT may be the same in order to facilitate their comparison. In one embodiment of the invention, if it is determined that the instant IOM exceeds the IOT, then the process may proceed to Step 208. On the other hand, in another embodiment of the invention, if it is alternatively determined that the instant IO is less than or equal to the IOT, then the process may alternatively proceed to Step 210.

In Step 208, after determining (in Step 206) that the instant IOM (obtained in Step 204) exceeds the IOT (identified in Step 202), a threshold value flag (TVF) is set. In one embodiment of the invention, the TVF may represent a flag variable that may be set (i.e., assigned a value equivalent to a binary or logical one) or cleared (i.e., assigned a value equivalent to a binary or logical zero) to indicate whether the TOT for the virtual machine has been met. After setting the TVF, the process may proceed to Step 220 (see e.g., FIG. 2B).

In Step 210, after alternatively determining (in Step 206) that the instant IOM (obtained in Step 204) does not exceed the IOT (identified in Step 202), another determination is made as to whether the TVF is set. Specifically, the TVF may be assessed to determine whether the value stored therein is equivalent to a binary or logical one. Accordingly, in one embodiment of the invention, if it is determined that the TVF is set, then the process may proceed to Step 220 (see e.g., FIG. 2B). On the other hand, if it is alternatively determined that the TVF is clear (i.e., stores a value equivalent to a binary or logical zero), then the process may alternatively proceed to Step 204, where the subsequent IOM may be obtained.

Turning to FIG. 2B, in Step 220, after setting the TVF (in Step 208) or, alternatively, after determining (in Step 210) that the TVF is set, a current timestamp (CT) is obtained. In one embodiment of the invention, the CT may represent encoded information that marks the date and/or time of a present moment.

In Step 222, a determination is made as to whether a difference in time between the LBT (obtained in Step 200) and the CT (obtained in Step 220) exceeds the ETT (identified in Step 202). The aforementioned difference in time may represent a measured duration of time that has elapsed since the last (or latest) backup operation for the virtual machine had been performed. In one embodiment of the invention, if it is determined that this difference in time exceeds the ETT, then the process may proceed to Step 224. On the other hand, if it is alternatively determined that this difference in time is less than or equal to the ETT, then the process may alternatively proceed to Step 204, where the subsequent TOM may be obtained.

In Step 224, after determining (in Step 222) that the difference in time between the LBT (obtained in Step 200) and the CT (obtained in Step 220) exceeds the ETT (identified in Step 202), a backup request is issued. In one embodiment of the invention, the backup request may be directed to a data protection service (DPS) (see e.g., FIG. 1) and may instruct the DPS to perform a backup operation (i.e., an auto-backup) to preserve the current virtual machine state, configuration, and/or metadata of the virtual machine. Further, in one embodiment of the invention, the backup request may specify a virtual machine identifier (ID) pertaining to the virtual machine, which would allow the DPS to identify the state, configuration, and/or metadata, associated with the virtual machine, to replicate and consolidate. In another embodiment of the invention, the backup request may further specify a backup type—i.e., a full backup or an incremental backup. With the addition of the backup type, the DPS may perform a backup operation that captures all state/configuration/metadata (i.e., a full backup) or merely changes to state/configuration/metadata (i.e., an incremental backup) that have transpired since the last/latest backup operation.

In Step 226, an acknowledgement of completion is received from the DPS. In one embodiment of the invention, the acknowledgement may be submitted, by the DPS, following completion of the backup operation targeting the current virtual machine state, configuration, and/or metadata of the virtual machine. Specifically, the DPS may submit the acknowledgement after: (a) the appropriate state/configuration/metadata for the virtual machine had been replicated; and subsequently thereafter, (b) the replicated state/configuration/metadata for the virtual machine had been securely consolidated on a backup storage system (BSS) (see e.g., FIG. 1). In one embodiment of the invention, the acknowledgement may take form as a message that confirms the completion of the virtual machine backup operation, which had been requested (in Step 224).

In Step 228, following receipt of the acknowledgement of completion (in Step 226), the TVF is cleared. In one embodiment of the invention, in clearing the TVF, the process to trigger the smart auto-backup is reset. Subsequently, hereinafter, the process may proceed to Step 200, where the process restarts again.

FIG. 3 shows a computing system in accordance with one or more embodiments of the invention. The computing system (300) may include one or more computer processors (302), non-persistent storage (304) (e.g., volatile memory, such as random access memory (RAM), cache memory), persistent storage (306) (e.g., a hard disk, an optical drive such as a compact disk (CD) drive or digital versatile disk (DVD) drive, a flash memory, etc.), a communication interface (312) (e.g., Bluetooth interface, infrared interface, network interface, optical interface, etc.), input devices (310), output devices (308), and numerous other elements (not shown) and functionalities. Each of these components is described below.

In one embodiment of the invention, the computer processor(s) (302) may be an integrated circuit for processing instructions. For example, the computer processor(s) may be one or more cores or micro-cores of a processor. The computing system (300) may also include one or more input devices (310), such as a touchscreen, keyboard, mouse, microphone, touchpad, electronic pen, or any other type of input device. Further, the communication interface (312) may include an integrated circuit for connecting the computing system (300) to a network (not shown) (e.g., a local area network (LAN), a wide area network (WAN) such as the Internet, mobile network, or any other type of network) and/or to another device, such as another computing device.

In one embodiment of the invention, the computing system (300) may include one or more output devices (308), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (302), non-persistent storage (304), and persistent storage (306). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

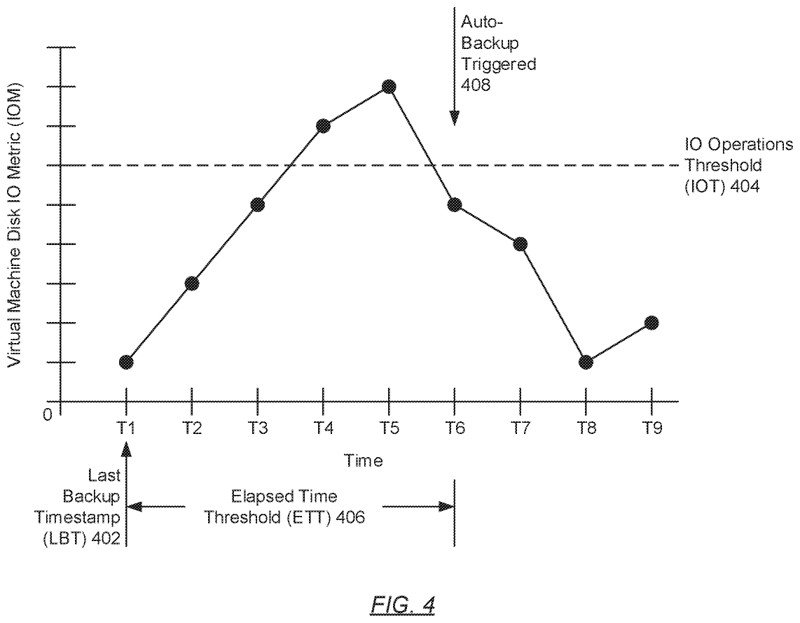

FIG. 4 shows an example scenario in accordance with one or more embodiments of the invention. The following example, presented in conjunction with components shown in FIG. 4, is for explanatory purposes only and not intended to limit the scope of the invention.

Turning to FIG. 4, a line-graph is portrayed that captures various disk input-output (IO) metric (IOM) values, representative of IO operations from a virtual machine, which has been monitored and polled over several time intervals (i.e., T1 to T9). The line-graph designates time as the independent variable (i.e., the x-axis), whereas values for the IOM are designated as the dependent variable (i.e., the y-axis). Further, the criteria for triggering an auto-backup of the virtual machine is also depicted—i.e., an IO operations threshold (IOT) (404) and an elapsed time threshold (ETT) (406). Moreover, assume an initial state of the threshold value flag (TVF) (not shown) is representative of the cleared state (i.e., a binary or logical zero). With the stage set, an account describing execution of embodiments of the invention (see e.g., FIGS. 2A and 2B) for each polled IOM value for the virtual machine follows.

By time interval T1, the last backup timestamp (LBT) (402) for the virtual machine is obtained. Also, a first IOM value is obtained. The first IOM value is determined to be lower than the IOT (404) and, based on this determination, the state of the TVF is assessed. Following the assessment, the state of the TVF is determined to be representative of the cleared state and, based on this determination, monitoring of IO operations associated with the virtual machine continues until a subsequent IOM value (i.e., a second IOM value) is obtained.

By time interval T2, the second IOM value is obtained. The second IOM value is determined to be lower than the IOT (404) and, based on this determination, the state of the TVF is assessed. Following the assessment, the state of the TVF is determined to be representative of the cleared state and, based on this determination, monitoring of IO operations associated with the virtual machine continues until a subsequent IOM value (i.e., a third IOM value) is obtained.

By time interval T3, the third IOM value is obtained. The third IOM value is determined to be lower than the IOT (404) and, based on this determination, the state of the TVF is assessed. Following the assessment, the state of the TVF is determined to be representative of the cleared state and, based on this determination, monitoring of IO operations associated with the virtual machine continues until a subsequent IOM value (i.e., a fourth IOM value) is obtained.

By time interval T4, the fourth IOM value is obtained. The fourth IOM value is determined to exceed the IOT (404) and, based on this determination, the state of the TVF is changed to be representative of the set state. Following the setting of the TVF, a first current timestamp (CT) is obtained. Next, a difference in time between the LBT (obtained by time interval T1) and the first CT is calculated. The difference in time is determined to be less than the ETT (406) and, based on this determination, monitoring of IO operations associated with the virtual machine continues until a subsequent IOM value (i.e., a fifth IOM value) is obtained.

By time interval T5, the fifth TOM value is obtained. The fifth IOM value is determined to exceed the IOT (404) and, based on this determination, a second CT is obtained. Next, a difference in time between the LBT (obtained by time interval T1) and the second CT is calculated. The difference in time is determined to be less than the ETT (406) and, based on this determination, monitoring of IO operations associated with the virtual machine continues until a subsequent IOM value (i.e., a sixth IOM value) is obtained.

By time interval T6, the sixth IOM value is obtained. The sixth IOM value is determined to be lower than the IOT (404) and, based on this determination, the state of the TVF is assessed. Following the assessment, the state of the TVF is determined to be representative of the set state (i.e., which the TVF transitioned into by time interval T4) and, based on this determination, a third CT is obtained. Next, a difference in time between the LBT (obtained by time interval T1) and the third CT is calculated. The difference in time is determined to meet the ETT (406) and, based on this determination, an auto-backup for the virtual machine is triggered (408). After completion of the backup operation, the state of the TVF is reverted back to be representative of the cleared state.

Embodiments of the invention relate to a method and system for implementing smart auto-backups of virtual machines using a virtual proxy. Existing solutions for protecting data use scheduled backups, which are pre-defined and do not account for the highly dynamic nature of, for example, application and database servers. That is, at any given time, these servers may experience large, non-deterministic (i.e., unpredictable) amounts of input-output (IO) operations to process. Further, processing of these IO operations may result in various changes to a current state of information consolidated on these servers, which have the potential of being lost when a failure event transpires between the scheduled backups. Embodiments of the invention address this shortcoming by monitoring for these unexpected surges in IO operations and, subsequently, triggering auto-backups so that the respective changes to state caused by the influx of IO operations may be preserved at any time prior to the scheduled backup. Accordingly, potential data loss is curbed.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for backing up virtual machines, comprising:
obtaining, for a virtual machine, a last backup timestamp (LBT);
monitoring disk input-output (IO) operations generated by the virtual machine, to obtain an IO operations metric (IOM);
making a first determination that the IOM exceeds an IO operations threshold (IOT);
making a second determination that a difference in time between a current timestamp (CT) and the LBT exceeds an elapsed time threshold (ETT); and
based on the first and second determinations:
issuing a backup request to perform an auto-backup of the virtual machine.

2. The method of claim 1, wherein the LBT encodes time information pertaining to a latest backup operation performed for the virtual machine.

3. The method of claim 2, wherein the latest backup operation is a periodic system-initiated backup.

4. The method of claim 1, wherein the IOM represents a polled disk IO performance metric, wherein the polled disk IO performance metric is one selected from a group consisting of IO throughput, IO bandwidth, and IO latency.

5. The method of claim 1, wherein the IOT is derived from historical IO operations information for the virtual machine.

6. The method of claim 1, wherein the backup request comprises a virtual machine identifier (ID) assigned to the virtual machine.

7. The method of claim 6, wherein the backup request further comprises a backup type, wherein the backup type is one selected from a group consisting of a full backup and an incremental backup.

8. A system, comprising:
a computer processor;
at least one virtual machine executing on the computer processor; and
a virtual proxy executing on the computer processor and operatively connected to the at least virtual machine,
wherein the virtual machine proxy is programmed to:
obtain, for the at least one virtual machine, a last backup timestamp (LBT);
monitor disk input-output (IO) operations generated by the at least one virtual machine, to obtain an IO operations metric (IOM);
make a first determination that the IOM exceeds an IO operations threshold (IOT);
make a second determination that a difference in time between a current timestamp (CT) and the LBT exceeds an elapsed time threshold (ETT); and
based on the first and second determinations:
issue a backup request to perform an auto-backup of the at least one virtual machine.

9. The system of claim 8, further comprising:
a virtual machine hypervisor (VMH) executing on the computer processor and programmed to manage the at least one virtual machine and the virtual proxy.

10. The system of claim 9, further comprising:
a physical storage array (PSA) operatively connected to the VMH, and comprising at least one virtual machine disk comprising state corresponding to the at least one virtual machine.

11. The system of claim 10, further comprising:
a virtual machine host comprising the computer processor, the at least one virtual machine, the virtual proxy, the VMH, and the PSA.

12. The system of claim 11, further comprising:
a data protection service (DPS) operatively connected to the virtual machine host, and programmed to:
receive the backup request issued by the virtual proxy; and
in response to the backup request:
perform a backup operation entailing replication of the at least one virtual machine disk to obtain at least one replica virtual machine disk.

13. The system of claim 12, further comprising:
a backup storage system (BSS) operatively connected to the DPS and the virtual proxy,
wherein the DPS is further programmed to:
upon completing the backup operation, consolidate the at least one replica virtual machine disk on the BSS.

14. A non-transitory computer readable medium (CRM) comprising computer readable program code, which when executed by a computer processor, enables the computer processor to:
obtain, for a virtual machine, a last backup timestamp (LBT);
monitor disk input-output (IO) operations generated by the virtual machine, to obtain an IO operations metric (IOM);
make a first determination that the IOM exceeds an IO operations threshold (IOT);
make a second determination that a difference in time between a current timestamp (CT) and the LBT exceeds an elapsed time threshold (ETT); and
based on the first and second determinations:
issue a backup request to perform an auto-backup of the virtual machine.

15. The non-transitory CRM of claim 14, wherein the LBT encodes time information pertaining to a latest backup operation performed for the virtual machine.

16. The non-transitory CRM of claim 15, wherein the latest backup operation is a periodic system-initiated backup.

17. The non-transitory CRM of claim 14, wherein the IOM represents a polled disk IO performance metric, wherein the polled disk IO performance metric is one selected from a group consisting of IO throughput, IO bandwidth, and IO latency.

18. The non-transitory CRM of claim 14, wherein the IOT is derived from historical IO operations information for the virtual machine.

19. The non-transitory CRM of claim 14, wherein the backup request comprises a virtual machine identifier (ID) assigned to the virtual machine.

20. The non-transitory CRM of claim 19, wherein the backup request further comprises a backup type, wherein the backup type is one selected from a group consisting of a full backup and an incremental backup.
